(19) United States
(12) Patent Application Publication
(10) Pub. No.: US 2005/0155519 A1
(43) Pub. Date: Jul. 21, 2005

(54) Granulation process

(76) Inventors: Henri Hansson, Helsingborg (SE); Elisabeth Lindner-Olsson, Hagersten (SE)

Correspondence Address: BURNS DOANE SWECKER & MATHIS L L P, POST OFFICE BOX 1404, ALEXANDRIA, VA, 22313-1404, US

(21) Appl. No.: 10/504,982

(22) PCT Filed: Feb. 25, 2003
(86) PCT No.: PCT/SE03/00299

(30) Foreign Application Priority Data
Feb. 25, 2002 (SE) 0200539-5

(51) Int. Cl. C08L 1/26

(52) U.S. Cl. 106/162.81

(57) ABSTRACT

A process for the manufacture of a corn starch granulate possessing resistance to enzymatic degradation upon oral administration, comprising the steps: a) granulating native corn starch by cautious mixing of a granulation fluid comprising methyl cellulose or ethyl cellulose as a binder, ethanol or water as a solvent, corn starch and a sweetener, b) subjecting the granulated material resulting from step a) to wet sieving; c) drying the granulate obtained in step b) at a temperature less than about 55° C. to avoid gelatinization of the corn starch; and d) sizing the dried granulate from step c) by dry sieving. A corn starch granulate and a corn starch granulate tablet also are provided.

### TECHNICAL FIELD OF THE INVENTION

The present invention relates to a process for the manufacture of a corn starch granulate possessing resistance to enzymatic degradation upon oral administration, to a corn starch granulate and to a corn starch granulate tablet comprising said corn starch granulate.

### BACKGROUND ART

Near normalization of blood glucose levels in diabetes is associated with around 50% less risk of nephropathy and retinopathy. However, the aim of normalizing the blood glucose levels is impeded by the risk of inducing hypoglycemia—the Achilles heel of diabetes management. Severe hypoglycemia is increased by 4-5 fold in patients with near-normal blood glucose levels by such normalization. A majority of these episodes occur during sleep. Nocturnal hypoglycemia represents a particularly threatening condition to the patient. At daytime, it is possible for the patient himself, or people in close proximity, to recognize and treat the early autonomic warning symptoms. At nighttime, however, when the patient is asleep the autonomic symptoms may not be enough to awaken the patient. Therefore an initially mild hypoglycemic episode may easily progress into a severe episode at a time when external assistance may not be available to the patient.

The causes of hypoglycemia may be recapitulated in a few key determinants. Available basal insulin formulations do not fully provide the required insulin supply at all times. Neither is food consumed in a standardized and consistent manner. Moreover, the nocturnal insulin effect reaches a peak around 3-5 a.m., a time when the dietary glucose is absorbed and the risk of hypoglycemia is at its greatest. Lowering the insulin dose is not a practical alternative because of the loss of blood glucose control on the following day. In contrast, an oral therapy that provides a ‘timed’ nocturnal glucose delivery may balance an excessive insulin effect without distorting blood glucose levels the following day.

In exploring the options to optimize the nocturnal glucose delivery different test-snacks have been tested. Normal snacks, such as bread or milk, produce a peak glucose delivery around 1-1½ hours after ingestion. Such a snack provokes early hyperglycemia without protecting against hypoglycemia after mid-night. A solution appears to be found in the use of particular starches characterized by a low rate of glucose delivery. Native corn starch has a peak glucose delivery at ˜4 hours. Corn starch is used to avert nocturnal hypoglycemia in young children with glycogen storage disease. Corn starch has also been tested in type 1 diabetic children. The comparison with a normal snack is clearly in favour of the corn starch regimen with regard to averting nocturnal hypoglycemia. It has been shown that corn starch consumption at bedtime leads to a 70% reduced number of hypoglycemic episodes at 3 a.m. in type 1 diabetic adults. Moreover, the regimen does not appear to compromise the glycemic control during a 4-week period, despite the fact that it is added as a supplement.

Native corn starch granules are used as the carbohydrate source. The granules range from approximately 2-32 μm in size.

Native corn starch is an odourless fine particular crystalline powder with a water content within 10-14%. The crystallinity can be observed in a polarised light microscope and particles, e.g. granules with a characteristic dark cross are evident.

The particle size together with the amount of intact granules is an important factor for the enzymatic degradation profile of native corn starch.

Starch granules are mainly made up of two components, amylose and amylopectin. Amylose has a linear structure while amylopectin is branched. Both amylose and amylopectin consist of α-(1,4)-linked glucose residues while amylopectin also has α-(1,6)-linked glucose residues. Starch granules are insoluble in cold water and swell in warm. The swelling is reversible until the temperature reaches 55-65° C.

Degradation of starch is catalysed by α-amylase. From amylose, the end products are maltose (approx. 90%) together with glucose and maltotriose. From amylopectin, the same end products are produced, together with branched oligosaccharides (α-dextrins). In man, α-amylase is present in saliva and in the small intestine. During in-vitro and in-vivo conditions the digestibility of starch depends on the source of starch as well as on the pre-treatment.

### SUMMARY OF THE INVENTION

The main object of the present invention is to provide a controlled, slow release of glucose from an ingestible corn starch product. Such a corn starch product is, in other words, upon intake capable to optimize the nocturnal glucose delivery to provide a “time” effective prophylaxis for nocturnal hypoglycemia to persons with diabetes.

Thus, it is an object of the invention to provide a process for the manufacture of such a corn starch product which will provide for controlled glucose delivery by its resistance to enzymatic degradation upon oral administration.

Another object of the invention is to provide a process which is adopted to industrial scale manufacture of such a corn starch product.

Another object of the invention is to provide corn starch products which will provide for controlled glucose delivery by their resistance to enzymatic degradation upon oral administration.

Yet another object of the invention is to provide corn starch products possessing the desired degradation profile in combination with agreeable taste and texture.

Still another object of the invention is to provide a process for the preparation of a corn starch product using mild operational conditions so as to maintain the primary corn starch granules intact as they appear in native corn starch.

Another object of the invention is to provide a corn starch formulation which on intake gives a desired increase in blood glucose levels for about 2 to 4 hours longer than would the native starch per se give, i.e. for a duration of up to about 6 to 8 hours.

For these and other objects which will be clear from the following disclosure the present invention provides for a process for the manufacture of a corn starch granulate possessing resistance to enzymatic degradation upon oral administration, comprising the steps:
a) granulating native corn starch by cautious mixing of a granulation fluid comprising methyl cellulose or ethyl cellulose as a binder, ethanol or water as a solvent, corn starch and a sweetener;
b) subjecting the granulated material resulting from step a) to wet sieving;
c) drying the granulate obtained in step b) at a temperature less than about 55° C. to avoid gelatinization of the corn starch; and
d) sizing the dried granulate from step c) by dry sieving.

The particle size of the granulate is crucial to achieve slow release of glucose. The conditions during the steps of granulation and subsequent sieving and drying all influence the particle size of the granulate. Cautious mixing is a prerequisite for successful sizing of the granulate at the end of its manufacturing process. Said cautious mixing is obtainable by a mixing operation which, when performed in a Diosna 600 liter granulator, is discontinued when a motor current of about 30 to 40 A, preferably about 33 to 36 A, is reached. The motor current corresponds to the force that is necessary to turn the rotor per meter of rotor. This endpoint reflects the final particle size of the granulate (see further below). Cautious mixing is also obtainable by mixing operations substantially equivalent to the one described above, but performed e.g. in another granulator.

To achieve a controlled, slow release of glucose the choice of binder is very important. Several common binders are unsuitable for use in this process. The most obvious example is pre-gelatinized starch, which is a source of quickly released glucose. Other common binders, e.g. gums and alginates, cause microbial damage and/or introduce less desirable texture to the product. In the process of the present invention the binder is selected from methyl cellulose and ethyl cellulose. The latter binders contribute to a slow release of glucose while they do not have any of the mentioned negative properties.

The preferred binder is ethyl cellulose. Ethyl cellulose is insoluble in water and thus more resistant to dissolution in the gastro-intestinal tract. A more resistant binder acts as a better barrier to degradation and hence contributes to a slow release profile. Further, ethyl cellulose is widely commercially available and a pharmacopeic substance.

To achieve a controlled, slow release of glucose the choice of sweetener is also very important. Common sweeteners as glucose and sucrose are unsuitable as they contribute to a fast release of glucose. Preferred sweeteners, such as isomalt, fructose, xylitol and aspartame, do not degrade to glucose.

The most preferred sweetener is isomalt, and optionally, aspartame. Isomalt is able to serve as a supplementary binder besides acting as a sweetener.

Other features of the process according to the invention are given in the appended claims.

The process according to the invention suitably involves a further step of pressing the granulate into tablets each weighing about 1 to 10 g. Such a weight allows for administration of the daily suitable amount of glucose in a reasonable number of tablets.

The mouthfeel of the tablet depends to a great extent on their hardness. More compressed tablets are more palatable, as the gritty properties of the starch granulate will be less evident in such tablets. The compression force exerted to press tablets may, however, cause damage to the native starch granules and hence increase the release rate of glucose. A combination of advantageous tablet properties is found when the tablets are pressed with a main compression force in the range of about 30 to 40 kN.

The present invention also relates to a corn starch granulate comprising primary corn starch granules as they appear in untreated native corn starch, said primary granules being agglomerated, without degradation thereof, into larger secondary granules to form a granulate using a binder selected from methyl cellulose and ethyl cellulose.

It is preferred that corn starch is a major constituent in the granules and that the binder is present in an amount of about 5 to 15% by weight based on the weight of the granulate.

However, the binder need not be pre-dissolved but can be admixed together with the other components.

It is preferred that corn starch is a major constituent in the granules and constitutes more than about half and preferably more than about ⅔ by weight of said granulate.

Such granulates preferably also comprise isomalt to assist in granulation and to add taste to the granulate. Isomalt is normally not utilized as a carbohydrate source in humans and will not significantly contribute with fast carbohydrates so as to compromise evening blood glucose levels. Furthermore, isomalt is also a less digestible carbohydrate source for bacteria in the mouth so as to further reduce the risk for caries.

Preferably the isomalt is present in an amount of about 5 to 30% based on the weight of the granulate.

The particle size of the primary starch granules and the secondary granules of the granulate is crucial to achieve slow release of glucose. In general, larger particles contribute to slower release of glucose.

Thus, it is preferred that the primary granules have an average cross dimension of about 15 to 25 μm.

It is further preferred that the secondary granules have an average cross dimension of about 0.3 to 1 mm. More specifically, to achieve the desirable release profile it is preferred that at least 75% of the secondary granules have an average cross dimension of at least 250 μm. However, particles<250 μm contribute in the formation of tablets of the granulate and should thus not be fully avoided if the granulate is to be used for the manufacture of tablets.

When scaling up the granulation process it was extremely difficult to produce a granulate giving the required release profile. Through optimization it was surprisingly found that the preferred particle size to give the desired release profile is >710 μm. Thus, more preferably 35 to 80% of the secondary granules have a average cross dimension of at least 710 μm.

Other features of the corn starch product according to the present invention are found in the appended claims. Such features involves the use of carefully selected additives to improve the taste of the granulate.

The fruit acid, such as malic acid, is used to stimulate the salivation during ingestion to reduce the perception of a “dry compound”. Furthermore, aroma is used to improve taste; lemon scent is especially well tasting in combination with the basic taste and texture of the formulation.

Aspartame was surprisingly shown to mask the “chalkyness” of the corn starch. Although not proved, it seems as though the perception of both the “chalkyness” and the sweet sensation of aspartame occurs in the brain at the same time, thus masking the chalky taste of corn starch.

The present invention also relates to a corn starch granulate tablet comprising said corn starch granulate, said tablet having a crushing strength of about 2 to 18 kp.

The mouthfeel of the tablet depends to a great extent on their hardness. Tablets having a high crushing strength are more palatable, as the gritty properties of the starch granulate will be less evident in such tablets. The compression force exerted to press tablets may, however, cause damage to the native starch granules and hence increase the release rate of glucose. A combination of advantageous tablet properties is found at a crushing strength in the range of about 2 to 18 kp.

The crushing strength is preferably in the range of about 8 to 14 kp, most preferably in the range of about 11 to 13 kp.

The weight of the tablet is preferably in the range of about 1 to 10 g. Such a weight allows for administration of the daily suitable amount of glucose in a reasonable number of tablets.

### BRIEF DESCRIPTION OF THE DRAWINGS

The present invention will be described more in detail in the following by specific examples and with reference to the appended drawings. The examples are not intended to limit the scope of the invention.

FIG. 1 shows a diagram on the blood glucose variation as a function of time comparing an embodiment of the corn starch product of the invention and a control devoid of corn starch in accordance with the invention. See Specific Example 3

FIG. 2 shows the release profiles for different fractions of a corn starch granulate. See Specific Example 4.

FIG. 3 shows the taste score given to corn starch granulate tablets of different crushing strengths by a taste panel. See Specific Example 5.

FIG. 4 shows the release profile of glucose for granulate tablets of different crushing strengths. See Specific Example 5.

### THE PROCESS IN GENERAL

The production process for the manufacture of corn starch granulate in accordance with the invention is generally a wet granulation process. A granulation fluid consisting of binder dissolved in denaturated or non-denaturated ethanol of 70-99.5% is produced. However, the binder need not be pre-dissolved but can be admixed together with the other components. The granulation fluid as obtained is added to a powder premix consisting of native corn starch and a sweetener and blended in a mixer or other means for mixing the constituents. The moist mixture is wet sieved or gently milled in an oscillating sieve or equivalent thereto. The wet mass obtained is dried to dryness at a temperature below about 55° C. The dried mass is dry sieved or gently milled to brake up larger lumps in an oscillating sieve or similar device. The dried granulates are then mixed with colloidal silica dioxide in an ordinary mixer, double cone mixer or similar apparatus. In a second mixing step magnesium stearate is admixed. Then tablets are compacted to give a crushing strength of about 2-18 kp in an ordinary tablet press.

### SPECIFIC EXAMPLE 1

Manufacture of Corn Starch Granulate

9.2 kg ethyl cellulose is dissolved in 28 kg ethanol (70-99.5%). 68.60 kg native corn starch and 16.25 kg isomalt are dry mixed in a mixer. After this mixing the ethanol containing ethyl cellulose is slowly added to the dry mass and mixing is continued until a uniformly wetted mass is obtained.

The wetted mass is then sized through a 1 to 2 mm screen or mill to give a wet granulate. This wet granulate is then dried on trays or in a fluidised bed at a temperature of less than about 55° C. to dryness. The dried granulate is then sized through a 1 to 2 mm screen or mill.

However, as previously indicated, the binder need not be pre-dissolved but can be admixed together with the other components.

Preparation of Corn Starch Tablets

The dried and sieved granulate obtained above is mixed with 1 kg colloidal silica for 10 minutes. 0.5 kg magnesium stearate is then added and mixing is carried out for about 2 minutes. The final mix obtained is transferred to the hopper of a tablet press equipped with Ø 15-25 mm punches with bevelled edges. Tablets of about 2 to 10 g are pressed to give a crushing strength of from about 12-14 kp.

### SPECIFIC EXAMPLE 2

Corn Starch Granulate

Corn starch granulate is manufactured as described in Example 1 above containing the following constituents given as percentage by weight.

| | |
|---|---|
| Corn starch | 72.9 |
| Ethyl cellulose | 9.7 |
| Isomalt PF | 15.1 |
| Malic acid | 0.6 |
| Aroma lemon (citro) | 0.2 |
| Aspartame | 0.04 |

Corn Starch Tablets

To a corn starch granulate having the composition given above Aerosil 200 1.0 and Mg-stearate 0.5 percent by weight are added for the transfer into tablets. The tablets have a weight of between about 2 to 10 g.

In the product described above in Example 2 corn starch has the advantage that it is an unsatisfactory carbohydrate source for the bacteria of the oral cavity thereby minimizing the risk for caries. Isomalt is added as an extra granulation component as well as sweetener. Isomalt is normally not utilized as a carbohydrate source in humans and will not significantly contribute with fast carbohydrates so as to compromise evening blood glucose levels. Furthermore, isomalt is also a less digestible carbohydrate source for bacteria in the mouth so as to further reduce the risk for caries.

The fruit acid, such as malic acid, is used to stimulate the salivation during ingestion to reduce the perception of a “dry compound”. Furthermore, aroma is used to improve taste; lemon scent is especially well tasting in combination with the basic taste and texture of the formulation.

Aspartame was surprisingly shown to mask the “chalkyness” of the corn starch. Although not proved, it seems as though the perception of both the “chalkyness” and the sweet sensation of aspartame occurs in the brain at the same time, thus masking the chalky taste of corn starch.

When tested in vivo, the corn starch product of the invention results in a blood glucose profile increasing linearly from about 45 minutes to about 5 hours, where-after it stays at the same level for at least about 2 more hours. This is totally unexpected when compared to the original release profile of native corn starch, which has a “low hill shaped” release profile. It is also quite unexpected to observe that such small amount of corn starch as 5-20 grams will secure the blood glucose levels for such a long period of time as about 7-8 hours.

### SPECIFIC EXAMPLE 3

Clinical Test

The patient arrives in the laboratory in the morning in fasting state and without having taken the regular morning insulin dose. For the establishment of a base line the blood glucose level will be stabilized at. 5.5 to 6.5 mmol per litre with the help of a slow i.e. infusion of insulin combined with a glucose infusion. The insulin is administrated by an infusion rate, aiming at giving a blood insulin concentration of 15-20 mU/l. The glucose concentration will be locked by customary clamp technique, where blood sugar is measured every 5^{th} minute for 1 hour and the glucose infusion rate is adjusted if necessary to give the desired blood glucose concentration. Thereafter the control medication is given and the glucose clamp is continued for 6 hours.

During the test, day blood samples are withdrawn every 10^{th} minute during the first 6 hours of the experiment for glucose determination, and also every 60^{th} minute for insulin determination.

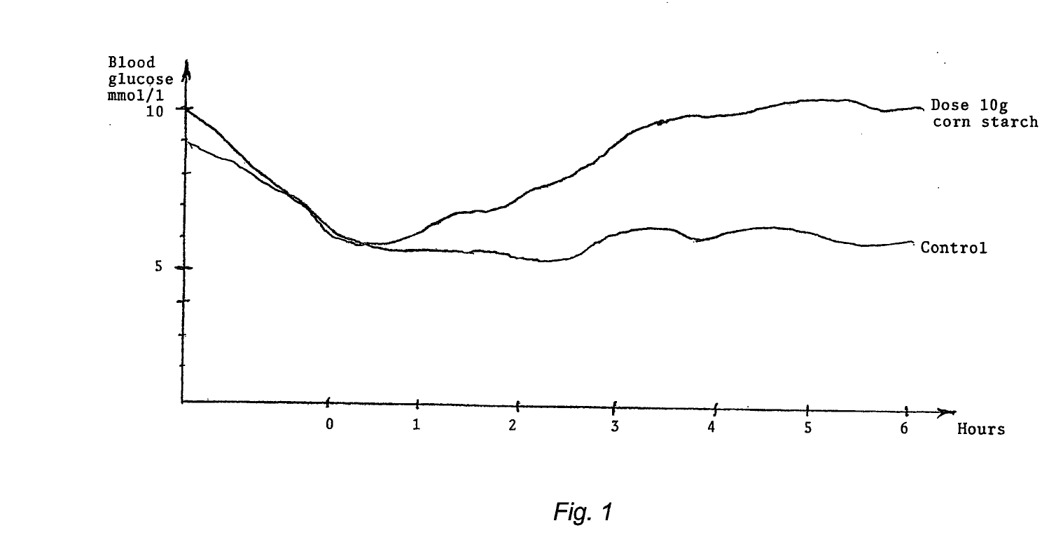

The result of the clinical test is summarized in the diagram of FIG. 1. Herein the blood glucose level in mmol/l is plotted as a function of time. Six tablets according to Specific Example 2 having a total weight of about 15 g and a total starch weight of about 10 g have been taken at time 0 and compared with a control not containing corn starch granulate according to the invention.

As is clear from the diagram, the blood glucose profile using the tablets of the present invention compared to the control is indeed surprisingly different and results in a pronounced increase in blood glucose level up to about 4-5 hours and then staying at the same level at least about 2 hours more. The blood glucose profile obtained by exercising the present invention indeed constitutes a great improvement in regard to the diabetes problem and greatly facilitates the treatment of diabetes with regard to the nocturnal hypoglycemia level in individuals suffering from diabetes.

Moreover, the tablets of this invention possess the unexpected feature of giving a slow release of the glucose contents of the starch in spite of the fact that the tablet is subjected to chewing.

### SPECIFIC EXAMPLE 4

Granulate Particle Size

A corn starch granulate of the formulation in Table 1 was produced according to the general method described in Specific Example 1. The granules were sieved and collected in the fractions 0-180 μm, 180-710 μm and 710-1400 μm. The fractions were analysed for their release profile based on enzymatic degradation.

TABLE 1

| Component | Amount (g) |
|---|---|
| Active substance | |
| Corn starch | 3,643 |
| Excipients | |
| Isomalt | 754 |
| Ethyl cellulose | 485 |
| Malic acid | 30 |
| Flav P Lemon caps | 11 |
| Aspartame powder | 2 |
| Colloidal silicon dioxide | 50 |
| Magnesium stearate | 25 |
| Total | 5,000 |

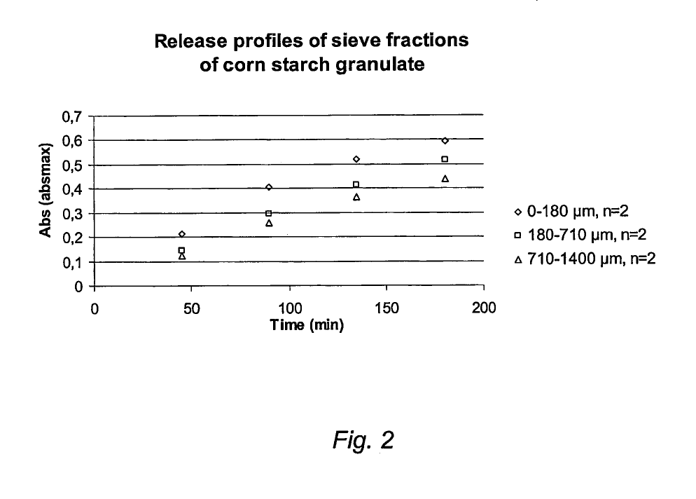

The release profiles of the fractions are shown in FIG. 2. The fractions consisting of the smallest granules (0-180 μm) resulted in highest absorbance and thus fastest release. The fractions consisting of the larger granules (180-710 μm and 710-1400 μm, respectively) resulted in lower absorbances and thus slower release profiles.

To achieve the desirable release profile, the particle size has now been optimized according to Table 2. The allowance of particles<250 μm is based on their contribution to compressibility.

TABLE 2

| Particle size (μm) | Weight (%) |
|---|---|
| >250 | 75 |
| >710 | 35-80 |
| <2000 | 100 |

### SPECIFIC EXAMPLE 5

Crushing Strength

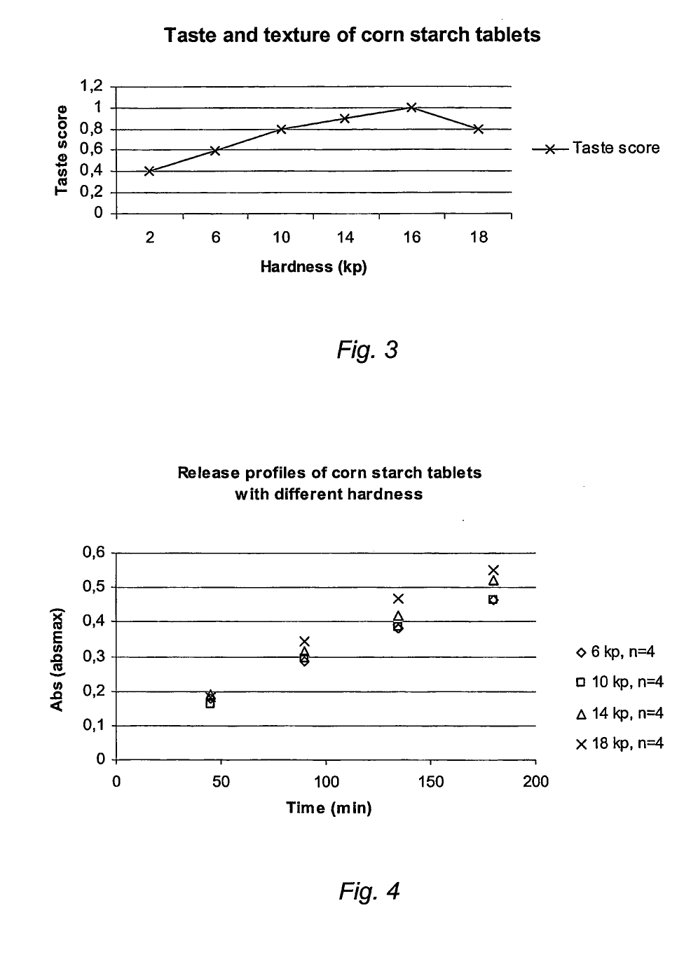

Tablets with different crushing strengths in the range of from 2 to 18 kp were prepared in lab scale from corn starch granulate according to Specific Example 2. A taste panel of six persons, scoring the different tablets on taste and texture judged the tablets. The results are shown in FIG. 3. The panel decided that the optimal crushing strength, from a taste/texture point of view, was approx. 16 kp.

When scaling up the tablet manufacture process to industrial scale and producing tablets with a crushing strength of 16 to 18 kp, as desired from a taste and texture perspective, the tablets did not show the desired controlled release curve, but a considerably faster release profile. Thus, it was surprisingly found that there was a reciprocal relationship between the release profile and the crushing strength, i.e. the softer the tablet the slower the release profile. The results are shown in FIG. 4.

For this reason, it was decided to combine a high crushing strength with a sustained release profile, e.g. about 8 to 14 kp, preferably about 11 to 13 kp.

1. A process for the manufacture of a corn starch granulate possessing resistance to enzymatic degradation upon oral administration, comprising the steps:
a) granulating native corn starch by cautious mixing of a granulation fluid comprising methyl cellulose or ethyl cellulose as a binder, ethanol or water as a solvent, corn starch and a sweetener;
b) subjecting the granulated material resulting from step a) to wet sieving;
c) drying the granulate obtained in step b) at a temperature less than about 55° C. to avoid gelatinization of the corn starch; and
d) sizing the dried granulate from step c) by dry sieving.

2. A process according to claim 1, wherein said binder is ethyl cellulose.

3. A process according to claim 1, wherein the sweetener is selected from isomalt, fructose, xylitol, and aspartame.

4. A process according to any claim 1, wherein said binder is admixed into ethanol or is admixed together with the other components.

5. A process according to claim 3, wherein said sweetener is selected from the group consisting of isomalt, and a combination of isomalt and aspartame.

6. A process according to claim 1, comprising the steps:
a) granulating native corn starch by cautious mixing of a granulating fluid comprising ethyl cellulose, preferably dissolved in ethanol and a premix of corn starch and isomalt as a sweetener;
b) subjecting the granulated material resulting from step a) to wet sieving by sizing through a screen or mill within the range about 1 to 3 mm;
c) drying the wet granulate obtained from step b) at a temperature of less than about 55° C.; and
d) sizing the dried granulate from step c) on a screen or mill within the range about 1 to 2 mm.

7. A process according to claim 1, wherein said cautious mixing is obtainable by a mixing operation which, when performed in a Diosna 600 liter granulator, is discontinued when a motor current of about 30 to 40 A is reached.

8. A process according to claim 1, comprising the further step of pressing the granulate into tablets each weighing 1 to 10 g.

9. A process according to claim 8, wherein said further step is comprised by mixing the granulate with colloidal silica for improving flow and with magnesium stearate as a lubricant before pressing the granulate into tablets.

10. A process according to claim 8, wherein the tablets are pressed to give a crushing strength of about 2 to 18 kp.

11. A process according to claim 8, wherein the tablets are pressed with a main compression force of about 30 to 40 kN.

12. Corn starch granulate obtained by the process of claim 1.

13. Corn starch granulate comprising primary corn starch granules as they appear in untreated native corn starch, said primary granules being agglomerated, without degradation thereof, into larger secondary granules to form a granulate using a binder selected from methyl cellulose and ethyl cellulose.

14. Granulate according to claim 13, wherein the binder is ethyl cellulose.

15. Granulate according to claim 13, wherein corn starch is a major constituent, and wherein the binder is present in an amount of about 5 to 15% by weight based on the weight of the granulate.

16. Granulate according to claim 15, wherein corn starch constitutes more than about half by weight of said granulate.

17. Granulate according to claim 13, further comprising isomalt to assist in granulation and to add taste to the granules.

18. Granulate according to claim 17, wherein isomalt is present in an amount of about 5 to 30% by weight based on the weight of the granulate.

19. Granulate according to claim 13, wherein a majority of the primary granules have an average cross dimension of about 15 to 25 μm.

20. Granulate according to claim 13, wherein a majority of the secondary granules have an average cross dimension of about 0.3 to 1 mm.

21. Granulate according to claim 13, wherein at least 75% of the secondary granules have an average cross dimension of at least 250 μm.

22. Granulate according to claim 20, wherein 35 to 80% of the secondary granules have an average cross dimension of at least 710 μm.

23. Granulate according to claim 13, further comprising aspartame to further add to the taste of the granulate.

24. Granulate according to claim 23, wherein aspartame is present in an amount of about 0.01 to 0.1% by weight based on the weight of the granulate.

25. Granulate according to claim 13, further comprising a fruit acid to add flavour to the granulate.

26. Granulate according to claim 25, wherein said fruit acid is selected from the group consisting of malic acid, tartaric acid, and citric acid.

27. Granulate according to claim 25, wherein said acid is present in an amount of about 0.1 to 1.5% by weight based on the weight of the granulate.

28. Granulate according to claim 13, further comprising an aroma substance.

29. Granulate according to claim 28, wherein said aroma substance is of citrus origin.

30. Granulate according to claim 28, wherein said aroma substance is present in an amount of about 0.1 to 1.0% by weight based on the weight of the granulate.

31. Corn starch granulate tablet obtained by the process of claim 8.

32. Corn starch granulate tablet comprising a corn starch granulate according to claim 13, said tablet having a crushing strength of about 2 to 18 kp.

33. Tablet according to claim 32, said tablet having a crushing strength of about 8 to 14 kp.

34. Tablet according to claim 33, said tablet having a crushing strength of about 11 to 13 kp.

35. Tablet according to claim 32, said tablet having a weight of about 1 to 10 g.

36. A process according to claim 2, wherein the sweetener is selected from isomalt, fructose, xylitol, and aspartame.

37. A process according to claim 4, wherein said sweetener is selected from the group consisting of isomalt, and a combination of isomalt and aspartame.

38. A process according to claim 1, wherein said cautious mixing is obtainable by a mixing operation which, when performed in a Diosna 600 liter granulator, is discontinued when a motor current of about 33 to 36 A is reached.

39. A process according to claim 9, wherein the tablets are pressed to give a crushing strength of about 2 to 18 kp.

40. Granulate according to claim 14, wherein corn starch is a major constituent, and wherein the binder is present in an amount of about 5 to 15% by weight based on the weight of the granulate.

41. Granulate according to claim 15, wherein corn starch constitutes more than about ⅔ by weight of said granulate.

42. Granulate according to claim 21, wherein 35 to 80% of the secondary granules have an average cross dimension of at least 710 μm.

43. Granulate according to claim 26, wherein said acid is present in an amount of about 0.1 to 1.5% by weight based on the weight of the granulate.

44. Granulate according to claim 29, wherein said aroma substance is present in an amount of about 0.1 to 1.0% by weight based on the weight of the granulate.

45. Tablet according to claim 33, said tablet having a weight of about 1 to 10 g.

46. Tablet according to claim 34, said tablet having a weight of about 1 to 10 g.
